(19) United States
(12) Patent Application Publication
(10) Pub. No.: US 2019/0265991 A1
(43) Pub. Date: Aug. 29, 2019

(54) METHOD FOR INTERWORKING BETWEEN HOST APPLICATION AND ASSISTANT APPLICATION AND ELECTRONIC DEVICE SUPPORTING THE SAME

(71) Applicant: SAMSUNG ELECTRONICS CO., LTD., Suwon-si (KR)

(72) Inventors: Heungki LEE, Suwon-si (KR); Sinwon SEO, Suwon-si (KR); Gaon YOON, Suwon-si (KR); Jehan YOON, Suwon-si (KR); Yeonoh CHOI, Suwon-si (KR)

(21) Appl. No.: 16/281,489

(22) Filed: Feb. 21, 2019

(30) Foreign Application Priority Data
Feb. 23, 2018 (KR) 10-2018-0022221

(51) Int. Cl. G06F 9/451; G06F 9/54; G06F 8/20; G06F 8/38

(52) U.S. Cl. CPC G06F 9/453; G06F 8/38; G06F 8/20; G06F 9/54

(57) ABSTRACT

An electronic device includes a memory configured to store at least one application including a host application having a plurality of functions and a management module comprising executable program elements. The management module provides the assistant application with at least one operation information corresponding to at least one function among the plurality of functions such that the assistant application is configured to interwork with a specified function corresponding to the assistant application among the at least one function depending on the at least one operation information regarding installation of an assistant application for the host application and provides the host application with interworking information with which the assistant application is configured to interwork with the specified function such that the host application links the assistant application with the specified function based on the interworking information regarding execution of the host application.

### CROSS-REFERENCE TO RELATED APPLICATION

This application is based on and claims priority under 35 U.S.C. § 119 to Korean Patent Application No. 10-2018-0022221, filed on Feb. 23, 2018, in the Korean Intellectual Property Office, the disclosure of which is incorporated by reference herein its entirety.

### BACKGROUND

### 1. Field

The disclosure relates to a service operating technology of an electronic device.

### 2. Description of Related Art

While electronic devices with independent operating systems are rapidly spreading, the electronic devices are supporting various functions or services. For example, an electronic device may support a service that provides search, reading, or product recommendation for a subject captured in an image (e.g., still image or video).

The service operation of the electronic device may be implemented depending on the specified series of routines on the internal frame work. As such, a formal service routine may limit a service interface or a service scenario, and it is difficult for the formal service routine to interwork with an external platform or to collaborate with a service.

The above information is presented as background information only to assist with an understanding of the disclosure. No determination has been made, and no assertion is made, as to whether any of the above might be applicable as prior art with regard to the disclosure.

### SUMMARY

Embodiments of the disclosure address at least the above-mentioned problems and/or disadvantages and to provide at least the advantages described below. Accordingly, an example aspect of the disclosure is to provide a method of interworking between a host application and an assistant application that is capable of providing various services by receiving a library including a unique service function from an external platform and referring to the library in a service operation, and an electronic device supporting the same.

In accordance with an aspect of the disclosure, an electronic device may include a memory storing at least one application including a host application having a plurality of functions and a management module.

In accordance with another example aspect of the disclosure, the management module comprising executable program elements is configured to provide the assistant application with at least one operation information corresponding to at least one function among the plurality of functions such that the assistant application is configured to interwork with a specified function corresponding to the assistant application among the at least one function depending on the at least one operation information, with regard to installation of an assistant application for the host application.

In accordance with another example aspect of the disclosure, the management module provides the host application with interworking information with which the assistant application is configured to interwork with the specified function such that the host application links the assistant application with the specified function based on the interworking information with regard to execution of the host application.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating an example management module of an electronic device, according to an embodiment;

FIG. 2A is a diagram illustrating an example host application of an electronic device, according to an embodiment;

FIG. 2B is a diagram illustrating an example operation process of a host application based on a second scenario mode, according to an embodiment;

FIG. 2C is a diagram illustrating an example operation process of a host application based on a third scenario mode, according to an embodiment;

FIG. 3 is a diagram illustrating an example partial configuration of an electronic device according to an embodiment;

FIG. 4 is a diagram illustrating an example user interface of a host application associated with installation of an assistant application, according to an embodiment;

FIG. 5A is a diagram illustrating examples of various user interfaces of a host application associated with a service operation, according to an embodiment;

FIG. 5B is a diagram illustrating examples of various user interfaces of a host application associated with a service operation, according to another embodiment;

FIG. 6 is a diagram illustrating example switching between a host application and an assistant application associated with a service operation, according to an embodiment;

FIG. 7 is a flowchart illustrating an example service operating method of an electronic device, according to an embodiment;

FIG. 8 is a flowchart illustrating an example process in which an electronic device installs an assistant application, according to an embodiment; and

FIG. 9 is a diagram illustrating an example electronic device in a network environment, according to an embodiment.

### DETAILED DESCRIPTION

Hereinafter, various example embodiments of the disclosure may be described with reference to accompanying drawings. Accordingly, those of ordinary skill in the art will recognize that various modifications, equivalents, and/or alternatives on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the disclosure, a first component may be referred to as a second component, and similarly, a second component may be referred to as a first component.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. On the other hand, when an component (e.g., a first component) is referred to as being “directly coupled with/to” or “directly connected to” another component (e.g., a second component), it should be understood that there is no intervening component (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” must not refer only “specifically designed to” in hardware. Instead, the expression “a device configured to” may refer, for example, to a situation in which the device is “capable of” operating together with another device or other parts. For example, a “processor configured to (or set to) perform A, B, and C” may refer, for example, and without limitation, to a dedicated processor (e.g., an embedded processor) for performing a corresponding operation, a generic-purpose processor (e.g., a central processing unit (CPU) or an application processor) which performs corresponding operations by executing one or more software programs which are stored in a memory device, or the like.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

An electronic device according to various example embodiments of the disclosure may include, for example, and without limitation, at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices, or the like. According to various example embodiments, the wearable device may include, for example, and without limitation, at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), a bio-implantable type (e.g., an implantable circuit), or the like.

According to various example embodiments, the electronic device may, for example, and without limitation, be a home appliance. The home appliances may include at least one of, for example, televisions (TVs), digital versatile disc (DVD) players, audio players, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another example embodiment, an electronic device may include, for example, and without limitation, at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automated teller machines (ATMs), points of sales (POSs) of stores, internet of things (e.g., light bulbs, various sensors, electric or gas meters, sprinkler devices, fire alarms, thermostats, street lamps, toasters, exercise equipment, hot water tanks, heaters, boilers, and the like), or the like.

According to an example embodiment, the electronic device may include, for example, and without limitation, at least one of parts of furniture or buildings/structures, electronic boards, electronic signature receiving devices, projectors, various measuring instruments (e.g., water meters, electricity meters, gas meters, or wave meters, and the like), or the like. According to various embodiments, the electronic device may be one of the above-described devices or a combination thereof. An electronic device according to an embodiment may be a flexible electronic device. Furthermore, an electronic device according to an embodiment of the disclosure may not be limited to the above-described electronic devices and may include other electronic devices and new electronic devices according to the development of technologies.

Hereinafter, electronic devices according to various example embodiments will be described with reference to the accompanying drawings. In the disclosure, the term “user” may refer to a person who uses an electronic device or may refer to a device (e.g., an artificial intelligence electronic device) that uses the electronic device.

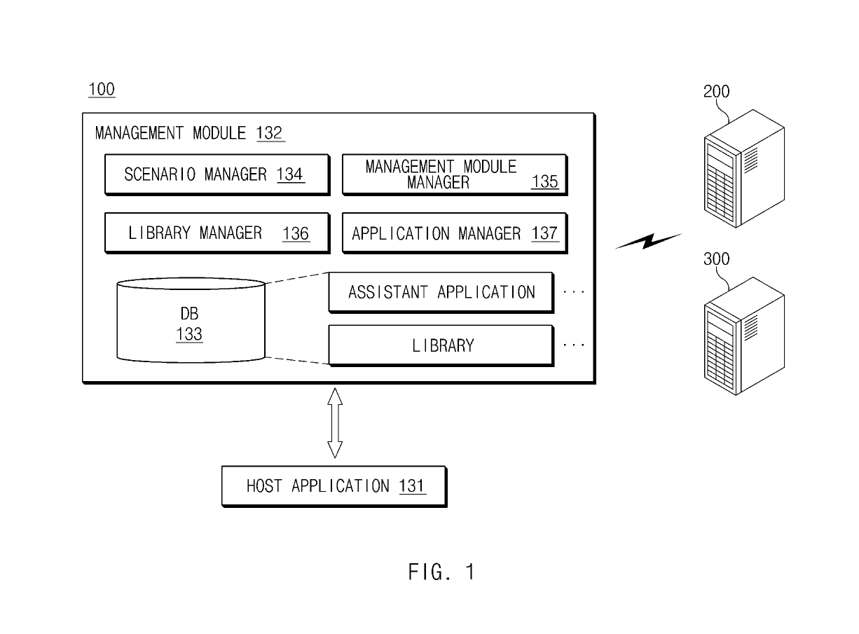

FIG. 1 is a diagram illustrating an example management module of an electronic device, according to an embodiment.

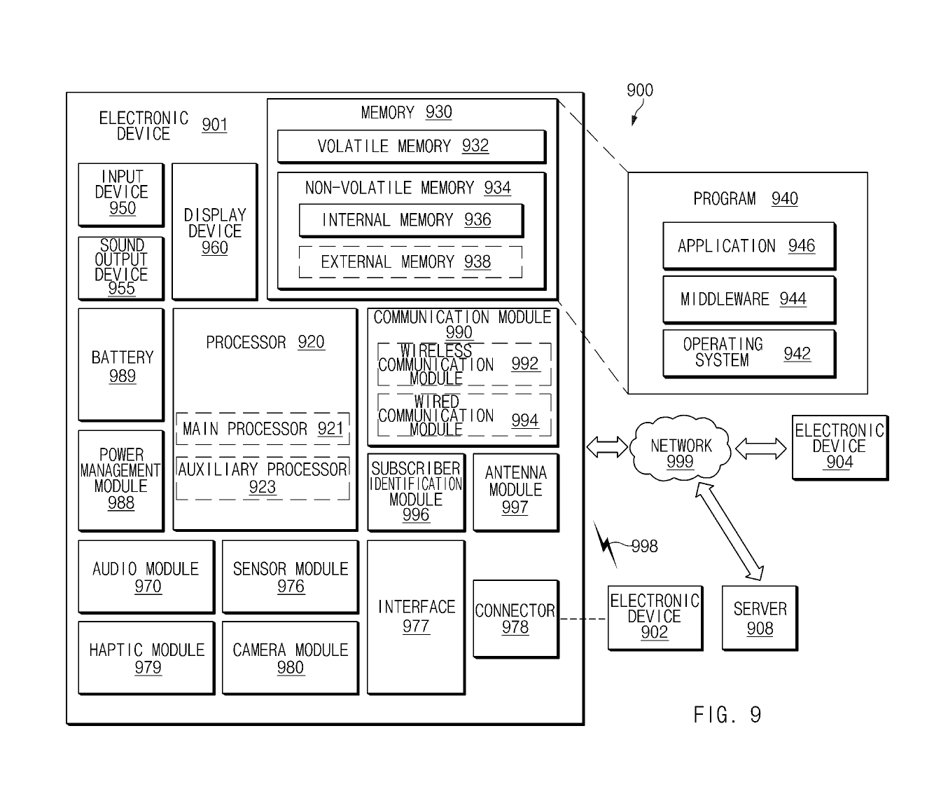

Referring to FIG. 1, an electronic device 100 (e.g., an electronic device 901 of FIG. 9) may include a management module (e.g., including processing circuitry and/or executable program elements) 132 (e.g., a frame work) for operating at least one service function based on the execution of a specified host application 131. In an embodiment, the management module 132 may include an environment or a system for collaborating with at least one external device to support the operation of the at least one service function. In various embodiments, the management module 132 may also be referred to as “middleware” 944 of the electronic device 901 described in greater detail below with reference to FIG. 9. Furthermore, the host application 131 and/or an assistant application described below may correspond to at least one application 946 included in the electronic device 901.

In an embodiment, the host application 131 may provide at least one service function based on an image (e.g., still image or video) capturing function of the electronic device 100. For example, the host application 131 may provide a service function that supports recommendation and purchase of goods associated with the captured subject or supports searching, reading, or the like of the subject. In this regard, the host application 131 may configure a service scenario for the at least one service function described above. In an embodiment, the service scenario may include at least one operation information associated with a service operation, and the operation information may include a series of sequences in conjunction with at least one unit operation. For example, the operation information may include at least one of first unit operation (e.g., image preview) information, second unit operation (e.g., image scan) information, third unit operation (e.g., image recognition), and/or fourth unit operation (e.g., additional service) information. In various embodiments, the at least one service function may include a service scenario including the operation information of types the same as or similar to one another or may include a service scenario including operation information, the at least part of which is different from one another. According to various embodiments, in the operation of the service scenario, the host application 131 may assign at least one unit operation, with which a service function by an external device may be associated, of at least one unit operation included in the service scenario.

In an embodiment, the electronic device 100 may distribute data for at least one service scenario configured by the host application 131 to at least one external device 200 through a software development kit. For example, the at least one external device 200 may include a server operated by the developer of a third-party application (hereinafter referred to as “developer-side server”), affiliated with the manufacturer of the electronic device 100 or the developer of the host application 131. The at least one external device 200 may include the developer-side server that is independent of the electronic device 100 and/or the host application 131. In an embodiment, at least one external device 200 may identify at least one service scenario provided by the electronic device 100 to determine whether to collaborate with the service function provided by the host application 131. For example, the first external device may determine whether there is operation information associated with the first service function capable of being provided from the first external device among the at least one operation information included in the service scenario. The first external device may determine whether the unit operation information, which is assigned to be linked by the host application 131, among the at least one operation information included in the service scenario is included. When there is operation information corresponding to the first service function of the first external device in the scenario of a specific service function and/or when there is the unit operation information assigned to be linked, the first external device may provide a library including data of the first service function capable of being provided, to a server 300 (or an online store (app store) server) operated by the manufacturer of the electronic device 100 (hereinafter referred to as “manufacturer-side server 300”). The first external device may exclude the attachment of data of the first service function in the library; when the host application 131 performs a unit operation corresponding to the first service function, the host application 131 may include an instruction to access the first external device. The first external device may generate an assistant application including the first service function to provide the assistant application to the manufacturer-side server 300.

According to various embodiments, even though the at least one operation information in the service scenario provided by the electronic device 100 does not correspond to the service function capable of being provided by the corresponding external device, the at least one external device 200 may provide the manufacturer-side server 300 with a library or assistant application for the service function capable of being provided. In various embodiments, in the operation of receiving a library or assistant application from the at least one external device 200, the manufacturer-side server 300 may perform authentication on the at least one external device 200, or may determinate the stability of installation or execution of the library or assistant application.

In an embodiment, the electronic device 100 may download the library or assistant application provided by the at least one external device 200 from the manufacturer-side server 300 in response to user control. The electronic device 100 may store the downloaded library or assistant application in a database 133 of the management module 132 by mapping the downloaded library or assistant application with the identification information (e.g., an external device identifier (e.g., an icon, a logo, a symbol, or the like) or service function information provided by an external device) of the external device (e.g., an external device providing the corresponding library or assistant application to the manufacturer-side server).

In an embodiment, the electronic device 100 may operate a service function supported by the host application 131 through the execution of the host application 131. In this example, the service function may be executed depending on the operation information on the service scenario configured by the host application 131. In an embodiment, when the first unit operation according to the service scenario is performed by the host application 131, identification information (e.g., the external device identifier such as an icon, a logo, a symbol, or the like) of the external device providing the library or assistant application for the service function corresponding to the first unit operation may be displayed on the user interface of the host application 131. When a second unit operation assigned to be linked to the above-described external device is performed by the host application 131, the identification information of the external device providing the service function for the assigned second unit operation may be displayed on the user interface of the host application 131. The pieces of identification information of all external devices to which the electronic device 100 provides the downloaded library or assistant application may be displayed on the user interface of the host application 131, regardless of the above-described unit operations. In this example, a first indication effect (e.g., blinking or color processing) may be assigned to the identification information of an external device providing a library or assistant application for the service function corresponding to the first unit operation among the pieces of identification information of the all external devices and a second display indication effect (e.g., dimming or blur processing) may be assigned to other identification information.

In an embodiment, a user input (e.g., touch, drag, or the like) may be applied to any one (hereinafter referred to as “first identification information”) of the pieces of identification information displayed on the user interface of the host application 131. In this example, the electronic device 100 may identify the library or assistant application mapped to the first identification information, with reference to the database 133 in the management module 132.

The electronic device 100 may display the content associated with the service function of the external device on the screen according to the execution of the first unit operation, using the data of the external device service function included in the identified library. The electronic device 100 may read out an instruction included in the identified library to access (e.g., communicate) an external device corresponding to the first identification information. In this example, the electronic device 100 may provide the accessed external device with data for the subject captured by the execution of the host application 131. The external device receiving the data for the subject may provide the electronic device 100 with the data for the service function corresponding to the subject, and the data for the service function may include, for example, augmented reality content data. The electronic device 100 may display content on the screen of the host application 131 according to the first unit operation, using the data of the service function received from the external device. Alternatively, the electronic device 100 may obtain data of service function from the identified assistant application to display the content on the screen according to the execution of the first unit operation or may execute the service functions included in the assistant application by executing the identified assistant application in the foreground and then outputting an independent user interface.

With respect to the above descriptions, the management module 132 of the electronic device 100 may include at least one program supporting a collaboration process between the host application 131 and the at least one external device 200. For example, the management module 132 may include at least one of a scenario manager (e.g., including processing circuitry and/or executable program elements) 134, a management module manager (e.g., including processing circuitry and/or executable program elements) 135, a library manager (e.g., including processing circuitry and/or executable program elements) 136, and/or an application manager (e.g., including processing circuitry and/or executable program elements) 137. In an embodiment, the scenario manager 134 may receive a service scenario for at least one service function from the host application 131 and may manage data for at least one operation information included in the scenario. The management module manager 135 may obtain at least one service scenario from the scenario manager 134 and may distribute data for the at least one operation information included in the service scenario to at least one external device 200 through a software development kit. The library manager 136 may manage the library downloaded from the manufacturer-side server 300 (or the online market (app store) server) and may load the specific library into the memory area of the electronic device 100 in response to a user input to call a specific library. The application manager 137 may manage the resource for at least one application mounted or installed on the electronic device 100. For example, the application manager 137 may manage the resource (e.g., data, instructions, or the like) for the host application 131 or at least one assistant application described above. Similarly to the library manager 136, the application manager 137 may load the resource associated with the host application or assistant application onto the memory area depending on a user input to control the execution of the host application or assistant application.

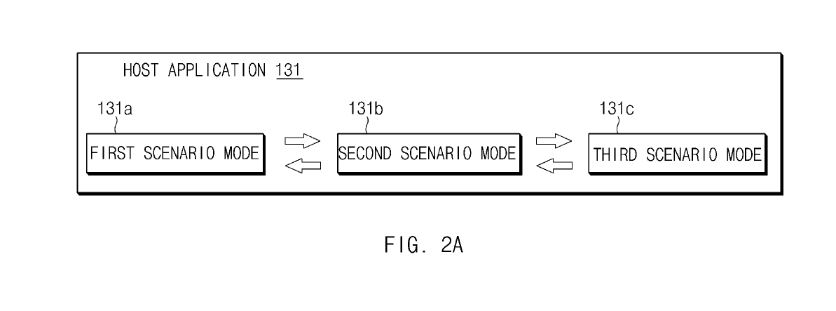

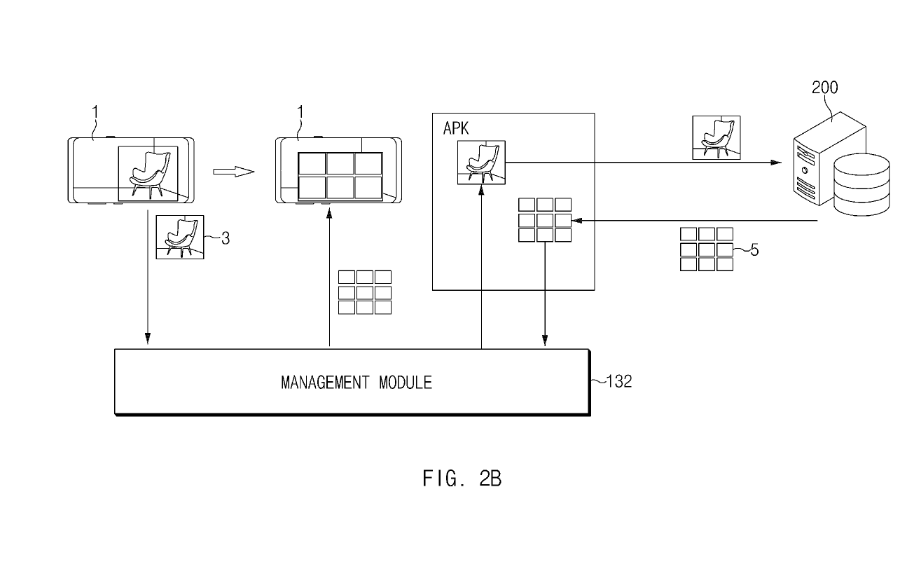

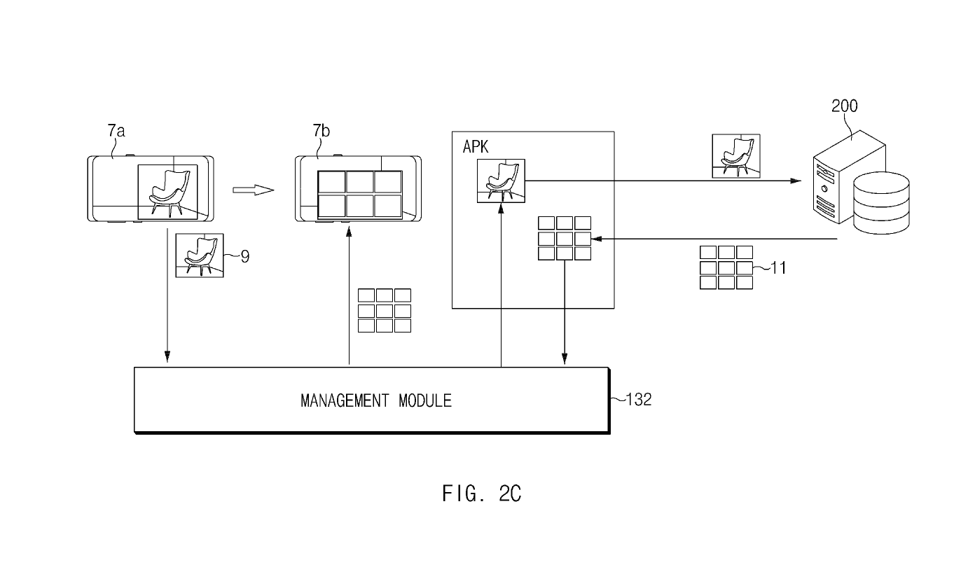

FIG. 2A is a diagram illustrating an example host application of an electronic device, according to an embodiment. FIGS. 2B and 2C are diagrams illustrating an example operation process of a host application based on various scenario modes, according to an embodiment.

The operation process of the host application illustrated in FIGS. 2B and 2C may be described as an example of performing a specific unit operation (e.g., image scan) included in the service scenario of a specific service function (e.g., subject search).

Referring to FIG. 2A, the host application 131 may include at least one of a first scenario mode (e.g., including processing circuitry and/or executable program elements) 131a, a second scenario mode (e.g., including processing circuitry and/or executable program elements) 131b, and/or a third scenario mode (e.g., including processing circuitry and/or executable program elements) 131c, which is associated with the operation mode of a service scenario according to a service function. In an embodiment, when the library mapped to the first identification information to which the user input is applied may include the service function data or when it is possible to obtain service function data from the mapped assistant application, the first scenario mode 131a may be activated. When the first scenario mode 131a is activated, the electronic device 100 of FIG. 1 may display the content according to the service function data on the screen being output at a user input time, using service function data included in the library or assistant application.

Referring to FIGS. 2A and 2B, the second scenario mode 131b may be activated when the library mapped to the first identification information, to which the user input is applied, includes an instruction to access the external device providing the library. When the second scenario mode 131b is activated, the electronic device 100 of FIG. 1 may transmit data of the object 3 detected on an image 1 captured through the host application 131, to the management module 132. The management module manager 135 of the management module 132 may transmit the data of the object 3 to the external device 200 providing the library, using, for example, APK. Accordingly, the external device 200 may identify the data of the object 3 and may transmit service function data 5 associated with the object 3 to the management module 132, using the APK. According to an embodiment, the service function data 5 may include augmented reality content associated with the object 3. The electronic device 100 may obtain the service function data 5 from the management module 132 to display the relevant content on the image 1. According to the above-described first scenario mode 131a or the above-described second scenario mode 131b, when the service function of the host application 131 is operated, the electronic device 100 may maintain the user interface of the host application 131 and may operate the service function provided from the external device.

Referring to FIGS. 2A and 2C, the third scenario mode 131c may be activated depending on the scheduling information of the electronic device 100 of FIG. 1 for the assistant application corresponding to the first identification information. In this regard, when being installed on the electronic device 100, the assistant application may be scheduled to be executed in the case where a user input is applied to the first identification information. For example, in an operation in which data of an object 9 is transmitted to the management module 132 after the object 9 is detected from an image 7a through the host application 131, when a user input is applied to the first identification information, the host application 131 may be switched to an assistant application corresponding to the first identification information. In this example, the electronic device 100 outputs an image 7b captured based on the execution of the assistant application, and the management module manager 135 of the management module 132 may transmit the data of the object 9 to the external device 200 associated with the assistant application, using the APK. The management module 132 receiving service function data 11 associated with the object 9 from the external device 200 may transmit the corresponding service function data 11 to the assistant application being executed, and the electronic device 100 may display content according to the service function data 11 through the assistant application. According to an embodiment, the function data 11 output after being provided from the external device 200 may include the augmented reality content for the image 7b including the object 9. According to the activation of the above-described third scenario mode 131c, upon operating a specific service function of the host application 131, the host application 131 may be switched to an assistant application providing a service function corresponding to a specific unit operation or a unit operation assigned to be linked to an external device.

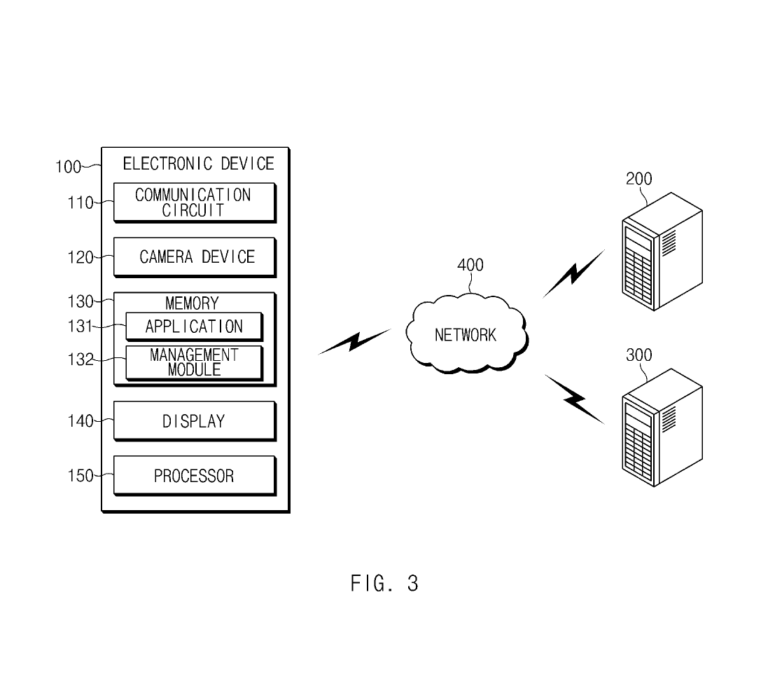

FIG. 3 is a diagram illustrating an example partial configuration of an electronic device according to an embodiment.

Referring to FIG. 3, the electronic device 100 (e.g., the electronic device 901 of FIG. 9) may include at least one of a communication circuit 110 (e.g., a communication module 990 of FIG. 9), a camera device 120 (e.g., a camera module 980 of FIG. 9), a memory 130 (e.g., a memory 930 of FIG. 9), a display 140 (e.g., a display device 960 of FIG. 9), and/or processor (e.g., including processing circuitry) 150 (e.g., a processor 920 of FIG. 9). According to various embodiments, the electronic device 100 may omit at least one of the above-described components or may further include another component. For example, the electronic device 100 may further include a power supply device (e.g., a battery 989 of FIG. 9) that supplies power to the components, a sensor device (e.g., a sensor module 977 of FIG. 9) (e.g., a proximity sensor, an illuminance sensor, an acceleration sensor, a fingerprint recognition sensor, or an iris recognition sensor) that senses various information about the operating environment of the electronic device 100. The electronic device 100 may further include components of the electronic device 901 to be described in greater detail below with reference to FIG. 9.

The communication circuit 110 may support communication between the electronic device 100 and at least one external device 200 and/or 300. For example, the communication circuit 110 may perform wired communication or wireless communication with at least one of the developer-side server 200 or the manufacturer-side server 300 depending on the specified protocol. In this regard, the communication circuit 110 may establish a network 400 with the at least one external device 200 and/or 300; the communication circuit 110 may transmit signal or data to the at least one external device 200 and/or 300 based on the connection to the network 400 through the wired communication or wireless communication or may receive a signal or data from the at least one external device 200 and/or 300.

The camera device 120 may capture an image (e.g., a still image, a video, or the like) of the operating environment of the electronic device 100. In an embodiment, the electronic device 100 may be equipped with a plurality of the camera devices 120 having angles of view (or at least partially overlapped angle of view) different from that one another. For example, a first camera device of a plurality of the camera devices 120 may be disposed in one area of the front surface of the electronic device 100 to capture a front area of the electronic device 100; a second camera device thereof may be disposed in one area of the rear surface of the electronic device 100 to capture a rear area of the electronic device 100. In an embodiment, the camera device 120 may operate after being triggered by the execution of the host application 131 of FIG. 1. Moreover, an image captured based on the execution of the host application 131 may be stored in the memory 130 in response to user control or specified scheduling information or may be transmitted to a specified external device (e.g., the developer-side server 200) through the communication circuit 110.

The memory 130 may store at least one data associated with the operation of the electronic device 100 or may store at least one instruction associated with the function operations of components of the electronic device 100. In an embodiment, the memory 130 may store at least one application 131, which is installed in the preloaded form when the electronic device 100 is manufactured or which is downloaded from the manufacturer-side server 300 (or, an online market (app store)). According to an embodiment, the at least one application 131 may include at least one of the above-described host application or the above-described assistant application. The memory 130 may store at least one library downloaded from the manufacturer-side server 300 (or provided from the developer-side server 200) with regard to the service function operation of the host application. In an embodiment, the memory 130 may include the management module 132 described above; as such, it is understood that the memory 130 includes at least one program (e.g., the scenario manager 134, the management module manager 135, the library manager 136, and/or the application manager 137 in FIG. 1) or the database 133 in FIG. 1.

The display 140 may output various screens or various pieces of content. For example, the display 140 may output the operation screen (e.g., a home screen, the execution screen of the application 131, or the like) of the electronic device 100 in response to the user control or the specified scheduling information or may output at least one content from at least one external device 200 and/or 300. In an embodiment, the display 140 may be implemented with a touch screen display including a display panel (including a display driver IC), a cover glass, and a touch panel (including a touch IC). The display panel may receive the driving signal corresponding to image information at the specified frame rate and may output the related screen based on the driving signal. The cover glass may be disposed on top surface of the display panel to pass through light according to the screen output of the display panel. Moreover, a user input (e.g., touch, drag, press, hovering, or the like) by a user's body (e.g., finger) or an electronic pen may be applied to at least one area of the cover glass. The touch panel may detect a signal according to a user input (e.g., electrostatic detection, pressure detection, infrared detection, ultrasonic detection, or the like) to output the detected signal as an electrical signal and may transmit information about the electrical signal to the processor 150.

The processor 150 may include various processing circuitry, such as, for example, and without limitation, one or more of a central processing unit (CPU), an application processor (AP), a communication processor (CP), or the like, and may be electrically or operatively connected to the components (e.g., the communication circuit 110, the camera device 120, the memory 130, the display 140, or the like) of the electronic device 100 described above. In an embodiment, the processor 150 may transmit the at least one instruction associated with the function operation to the component or may perform various operations or data processing to control the component. As such, it is understood that the function operation of the electronic device 100, the management module 132, or the host application 131 of FIG. 1 described with reference to the previously referenced drawings is performed under control of the processor 150. For example, the processor 150 may allow the host application to configure the service scenario associated with the at least one function service or to execute the function service or may allow the management module 132 to distribute data for the service scenario to the at least one developer-side server 200 through a software development kit. Alternatively, the processor 150 may download the at least one library or an assistant application from the manufacturer-side server 300 to establish the database 133 of FIG. 1.

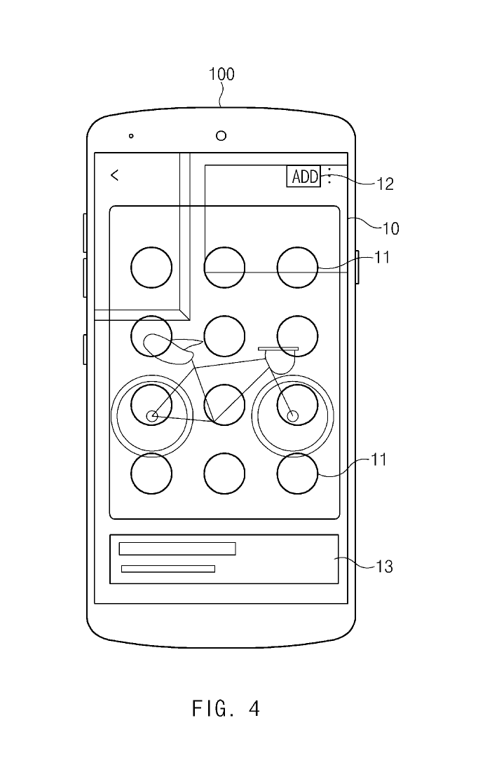

FIG. 4 is a diagram illustrating an example user interface of a host application associated with installation of an assistant application, according to an embodiment.

Referring to FIG. 4, the processor 150 in FIG. 3 of the electronic device 100 may output a first user interface 10 according to the execution of the host application 131 in FIG. 1. In various embodiments, the first user interface 10 may be a main screen of the host application 131 or a screen capable of being entered through a specific menu provided by the host application 131.

In an embodiment, the first user interface 10 may include identification information 11 (e.g., an identifier icon, a logo, a symbol, or the like) of at least one developer-side server 200 of FIG. 2 (hereinafter referred to as “second server”) providing the manufacturer-side server 300 of FIG. 3 (hereinafter referred to as “first server”) with a library or an assistant application. The first user interface 10 may include only the identification information 11 of the second server 200 authenticated by the first server 300 among the at least one second server 200 providing the library or assistant application with the first server 300. With regard to the output of the first user interface 10, the electronic device 100 may periodically or randomly receive information about the at least one second server 200 providing (or authenticating) the library or assistant application, from the first server 300 to configure or update the first user interface 10.

In an embodiment, at least one identification information 11 may support the download of a library or assistant application from the first server 300. For example, when a specified user input (e.g., double touch or long press) is applied to any one of the at least one identification information 11, the processor 150 of the electronic device 100 may access the first server 300 to download the library or assistant application of the second server 200 corresponding to the identification information selected from the user.

In various embodiments, in response to a user input (e.g., touch) applied to a specified tap button 12, the first user interface 10 may switch at least one identification information 11 displayed to at least another identification information to display the at least another identification information or may display at least another identification information through the section movement. Also, when a user input (e.g., touch) is applied to any one of at least one identification information 11, an interface 13 for providing service function information (e.g., a text, a thumbnail image, or the like) of a library or assistant application corresponding to the selected identification information may be displayed on the first user interface 10. In various embodiments, at least one identification information 11 included in the first user interface 10 is not limited to the illustrated shape, arrangement, or quantity.

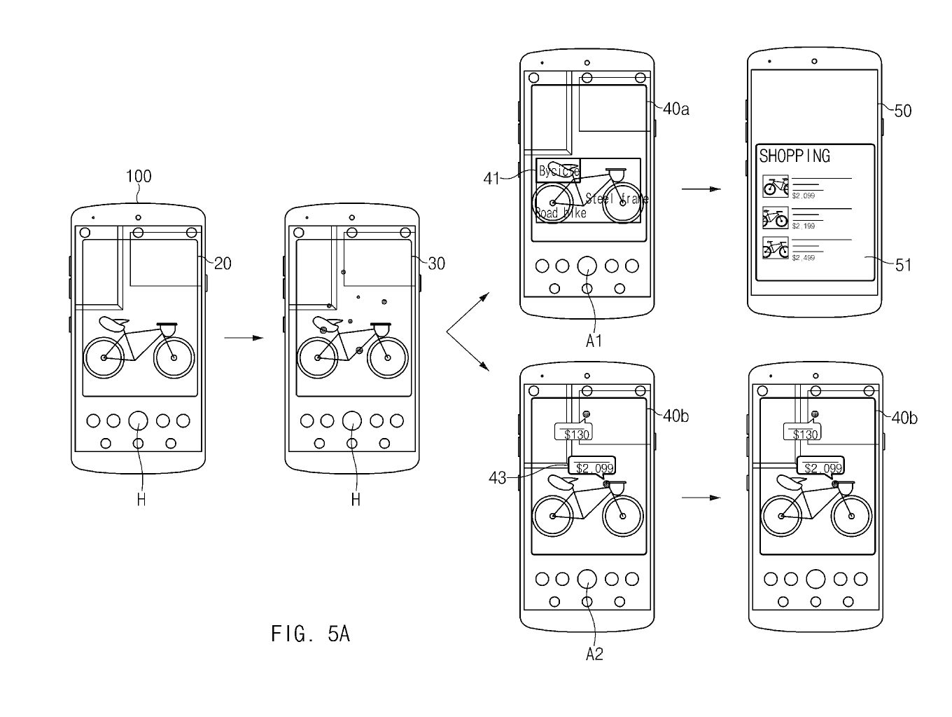

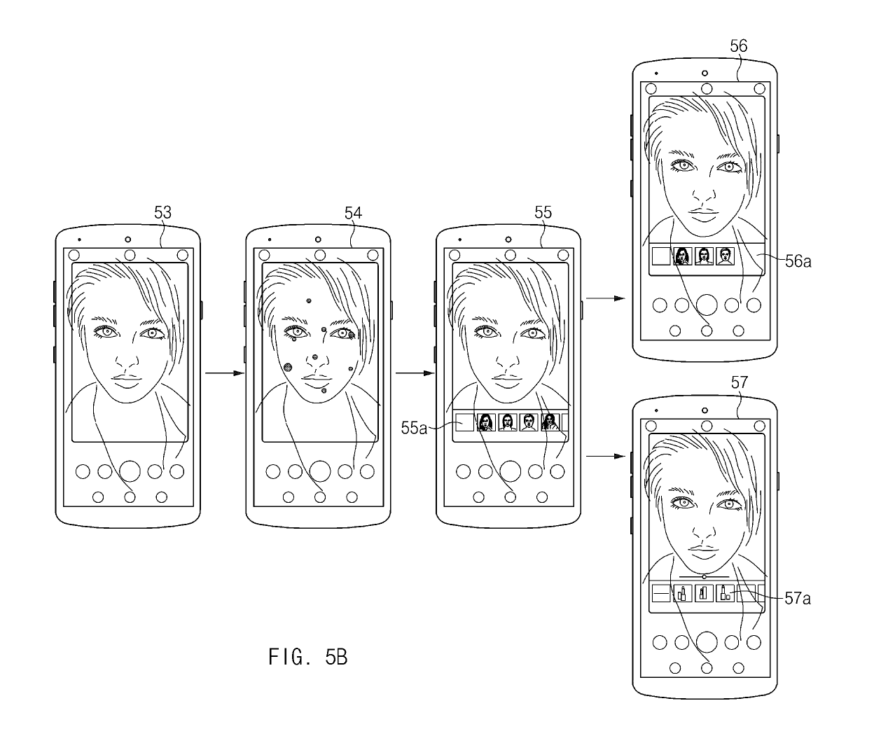

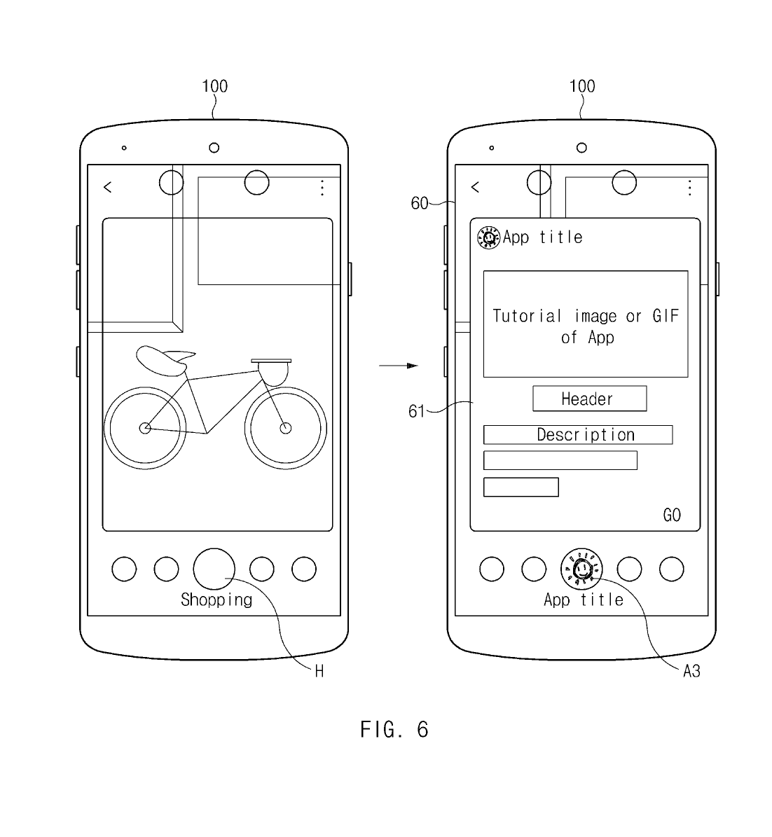

FIGS. 5A and 5B are diagrams illustrating various example user interfaces of a host application associated with a service operation, according to an embodiment. FIG. 6 is a diagram illustrating an example of switching between a host application and an assistant application associated with a service operation, according to an embodiment.

Referring to FIG. 5A, when operating the specific service function (e.g., product recommendation and purchase service) of the host application 131 of FIG. 1, the electronic device 100 may be based on the service scenario configured for the particular service function. In an embodiment, a second user interface 20 of the host application 131 according to the first unit operation (e.g., image preview) of the service scenario may include identification information (e.g., an external device identifier such as an icon, a logo, a symbol, or the like) of an external device providing the library or assistant application for the service function corresponding to the first unit operation. In the embodiment according to FIGS. 5A and 5B, it may be understood that a separate user input is not applied to at least one identification information included in the second user interface 20 according to the first unit operation and a third user interface 30 according to the second unit operation (e.g., image scan). As such, the identification information H of the host application may be in a focused state on the second user interface 20 and the third user interface 30.

According to an embodiment, in the third unit operation (e.g., image recognition) according to the service scenario, the first identification information A1 of the at least one identification information (e.g., identification information of the external device providing the library or assistant application for the service function corresponding to the third unit operation) displayed on a fourth user interface 40a according to the third unit operation may be selected (or focused) by a user input. In this case, the electronic device 100 may obtain service function data with reference to a library mapped to the first identification information A1 and may display at least one content 41 associated with the third unit operation on the fourth user interface 40a by using the service function data.

The electronic device 100 may communicate with an external device associated with the first identification information A1 by reading out instructions in the library mapped to the first identification information A1. The electronic device 100 may transmit subject data on the image recognized through the third unit operation (e.g., image recognition), to an external device associated with the first identification information A1. In this example, the external device may provide service function data (e.g., augmented reality content data) corresponding to the subject information to the electronic device 100. The electronic device 100 may display the content 41 on the fourth user interface 40a using the service function data provided from the external device.

The electronic device 100 may obtain the service function data from the assistant application mapped to the first identification information A1 to display the content 41 on the fourth user interface 40a

According to an embodiment, the service functions provided by each external device corresponding to the at least one identification information are at least partially different from each other, and thus content 41 displayed on the fourth user interface 40a in the case where the first identification information A1 is selected and content 43 displayed on a fourth user interface 40b in the case where the second identification information A2 is selected may include at least some aspects different from each other.

According to an embodiment, after the content 41 is displayed depending on the first identification information A1 of the user's selection, when the specified time has elapsed, the host application 131 may perform a fourth unit operation (e.g., additional service) according to the service scenario. When the external device, library, or assistant application, which corresponds to the first identification information A1 in the focused state, provides the service function data associated with the fourth unit operation, content 51 according to the provided service function data may be displayed on a fifth user interface 50 according to the fourth unit operation.

When the external device, library, or assistant application, which corresponds to the second identification information A2 selected by the user does not provide a service function associated with the fourth unit operation upon performing the third unit operation, the fourth user interface 40b according to the execution of the third unit operation may be maintained without separate switching.

Referring to FIG. 5B, the host application 131 may operate a service function (e.g., a beauty service) different from the above-mentioned service. An embodiment is illustrated by way of non-limiting example in FIG. 5B as a separate user input does not occur on a sixth user interface 53 of the first unit operation (image preview) and a seventh user interface 54 of the second unit operation (e.g., image scan) according to the service function.

In an embodiment, when the specified time has elapsed after the output of the seventh user interface 54 according to the second unit operation, the host application 131 may perform the third unit operation (e.g., image recognition). In this operation, a user input may be applied to the first identification information of the at least one external device identification information displayed on an eighth user interface 55 according to the third unit operation. In this example, the electronic device 100 may identify the assistant application corresponding to the first identification information with reference to the database 133 in FIG. 1. In an embodiment, the identified assistant application may be executed depending on the scheduled information instead of the host application 131.

The electronic device 100 may transmit the data of a subject recognized through the third unit operation, to the external device associated with the assistant application through the APK of the identified assistant application. The external device may provide the electronic device 100 with the service function data corresponding to subject data through the APK of the assistant application. The electronic device 100 may output content 55a according to the service function data (e.g., a makeup style, a hairstyle, an image effect filter service, or the like) received from the external device on the eighth user interface 55 output by the assistant application being executed. In various embodiments, depending on the user input to the content 55a provided by the assistant application, a ninth user interface 56 or a tenth user interface 57 of the fourth unit operation (e.g., additional service) performed by the assistant application may include different pieces of content. For example, the ninth user interface 56 may include content 56a associated with the hairstyle service, and the tenth user interface 57 may include content 57a associated with a makeup style or types.

Referring to FIG. 6, in an operation of performing a specific function service of the host application 131 in FIG. 1 depending on a service scenario configured for the specific function service, the electronic device 100 may switch the execution of the host application to the execution of a specific assistant application. For example, when the assistant application corresponding to the identification information A3 selected from a user on a user interface 60 of the specific unit operation according to the service scenario is scheduled to be executed after being triggered by the selection of the identification information of the user, an interface 61 that supports switching to the assistant application may be displayed on the user interface 60. In this operation, the electronic device 100 may transmit data for the subject (or recognized subject) captured based on the execution of the host application 131, to an external device associated with the assistant application. The external device may identify the subject transmitted from the electronic device 100 and may transmit data for the content corresponding to the subject (e.g., augmented reality content) to the host application 131 depending on whether the user manipulates the interface 61 or may transmit the data to the assistant application, the execution of which is switched. The electronic device 100 may output the content provided from the external device, through the host application 131 or the assistant application.

According to various embodiments, the provision of the service function according to the collaboration between the host application 131 and the at least one external device described above may be implemented without limitation for the first to fourth unit operations. For example, when the service function of the external device collaborates upon performing the fourth unit operation, the host application may perform the first to third unit operations depending on the service scenario configured for the service function and may operate the service function provided by the external device upon performing the fourth unit operation.

When the service function of the external device collaborates upon performing the first unit operation, the host application may operate the service function of the external device upon performing the first unit operation and may operate various service functions of the external device depending on whether the external device provides an additional service function with respect to the second to fourth unit operations after the first unit operation or may perform the second to fourth unit operations according to the configured service scenario.

According to various embodiments of the disclosure, an electronic device may include a memory storing at least one application including a host application having a plurality of functions and a management module.

According to various embodiments, the management module may be configured to provide the assistant application with at least one operation information corresponding to at least one function among the plurality of functions such that the assistant application interworks with a specified function corresponding to the assistant application among the at least one function depending on the at least one operation information with regard to installation of an assistant application for the host application and to provide the host application with interworking information in which the assistant application interworks with the specified function such that the host application links the assistant application with the specified function based on the interworking information with regard to execution of the host application.

According to various embodiments, the electronic device may further include a communication circuit.

According to various embodiments, the management module may be configured to download at least one assistant application associated with the specified function from a specified external device, using the communication circuit.

According to various embodiments, the management module may be configured to map the downloaded at least one assistant application to at least one execution mode information associated with the downloaded at least one assistant application to store the mapped result.

According to various embodiments, the electronic device may further include a display and a processor electrically connected to the memory, the communication circuit, and the display.

According to various embodiments, the processor may be configured to output a first user interface for supporting download of the assistant application associated with the specified function from the specified external device, using the display when the host application is executed.

According to various embodiments, the processor may be configured to output at least one second user interface corresponding to the at least one operation information, using the display when the host application is executed.

According to various embodiments, the processor may be configured to display identification information associated with the assistant application on the at least one second user interface.

According to various embodiments, the processor may be configured to receive a user input signal applied to the identification information and to identify the assistant application associated with the identification information.

According to various embodiments, the processor may be configured to display content associated with a function included in the identified assistant application, on the second user interface.

According to various embodiments, the processor may be configured to execute the identified assistant application and to output content associated with a function included in the assistant application, through the executed assistant application.

According to various embodiments, the plurality of functions may include at least one of a product recommendation function, a subject search function, or a subject recognition function, based on image capture.

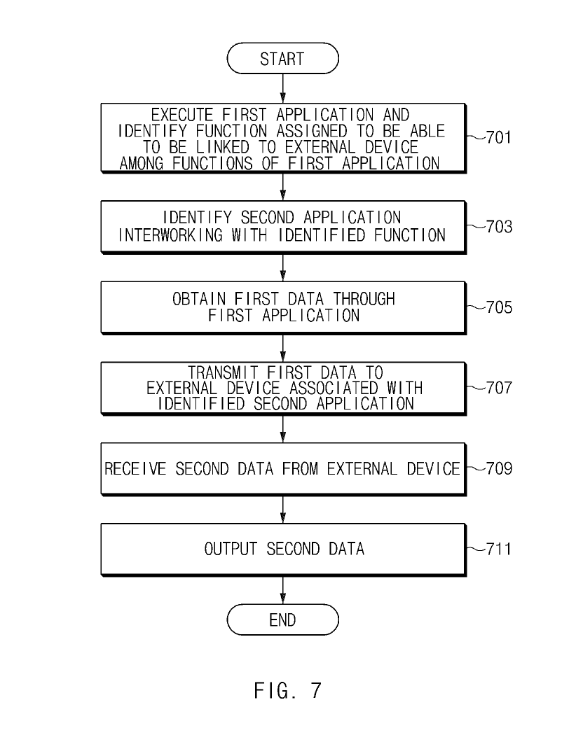

FIG. 7 is a flowchart illustrating an example method of interworking between a host application and an assistant application, according to an embodiment.

Referring to FIG. 7, in operation 701, the electronic device 100 of FIG. 3 (e.g., the processor 920 of FIG. 9) may execute a first application (e.g., the host application 131 of FIG. 1) and may operate a service function based on an image capture function. In this regard, the first application may configure a service scenario for the service function. In an embodiment, the service scenario may include at least one unit operation, and at least part of the at least one unit operation may be assigned such that a service function by an external device is capable of being linked by a first application.

In an embodiment, identification information (e.g., an icon, a logo, a symbol, or the like) of at least one external device providing a service function capable of being linked to the specific unit operation may be displayed on the user interface of a specific unit operation according to the service function operation of the first application. In an embodiment, when a user input is applied to the specific identification information of the at least one identification information, the electronic device 100 (e.g., the processor 920 of FIG. 9) may determine whether a specific unit operation of the first application is assigned to be linked to an external device.

When the specific unit operation is a specified unit operation capable of being linked to an external device in operation 701, in operation 703, the electronic device 100 (e.g., the processor 920 of FIG. 9) may identify a second application providing a service function with respect to the specific unit operation. For example, the electronic device 100 (e.g., the processor 920 of FIG. 9) may identify the second application corresponding to specific identification information to which a user input is applied, with reference to the database 133 of FIG. 1 including at least one application identification information installed in the electronic device 100. In various embodiments, the second application may be executed depending on the scheduled information, instead of the first application in operation 703.

In operation 705 and operation 707, the electronic device 100 (e.g., the processor 920 of FIG. 9) may obtain first data for the subject on the image captured by the first application in operation 701 and may provide the obtained first data to an external device associated with the second application through the APK of the first application or second application, which is executing.

In operation 709, the electronic device 100 (e.g., the processor 920 of FIG. 9) may receive second data associated with the first data for the subject from the external device through the APK of the second application. In an embodiment, the second data may include at least one augmented reality content associated with the subject.

In operation 711, the electronic device 100 (e.g., the processor 920 of FIG. 9) may output content according to the second data received from the external device through the execution of the first application or second application.

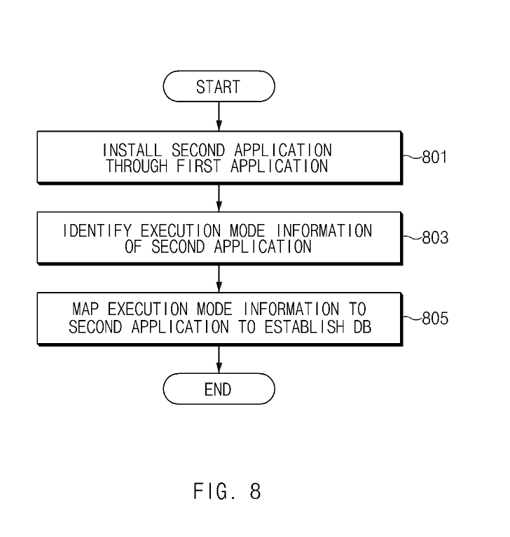

FIG. 8 is a flowchart illustrating an example process in which an electronic device installs an assistant application, according to an embodiment.

According to an embodiment, the electronic device 100 of FIG. 3 may operate the service function of the host application described above, based on the execution mode information of the at least one assistant application identified upon installing at least one assistant application.

Referring to FIG. 8 with regard to details described above, in operation 801, the electronic device 100 (e.g., the processor 920 of FIG. 9) may install at least one second application (e.g., assistant application) through a first application (e.g., a host application). In an embodiment, the electronic device 100 (e.g., the processor 920 of FIG. 9) may provide a list of at least one second application capable of being installed in the electronic device 100, through the first user interface output 10 of FIG. 4 output according to the execution of the first application. In various embodiments, the list of the second application may include a specified array of at least one or more pieces of identification information (e.g., an icon, a logo, a symbol, or the like) associated with the second application. In an embodiment, the electronic device 100 (e.g., the processor 920 of FIG. 9) may download the second application corresponding to the selected identification information from a specified server (e.g., the manufacturer-side server 300 of FIG. 300, an app store server, or the like) corresponding to a user input (e.g., double touch, long press, or the like) applied to one of the at least one identification information.

In operation 803, the electronic device 100 (e.g., the processor 920 of FIG. 9) may identify the execution mode information about the downloaded or installed at least one second application. In this regard, the at least one second application may include unique execution mode information. For example, in an operation of distributing data for at least one service scenario configured in the first application from the electronic device 100 (e.g., the processor 920 of FIG. 9) to the external device associated with the at least one second application, the execution mode information may be set or determined by the external device.

In an embodiment, the execution mode information may include at least one of first execution mode information, second execution mode information, third execution mode information, or fourth execution mode information. In an embodiment, the first execution mode may receive the control of the first level (e.g., link) from the first application upon providing a service function in conjunction with the first application and the second application. For example, the second application in the first execution mode may receive a starting point (e.g., unit operation), at which the second application is to interwork, from the first application in the hyperlink form and may be executed independently of the first application after the starting point of the interworking to provide a service function. In an embodiment, the second execution mode may receive the control of the second level (e.g., simple binding) from the first application upon providing a service function in conjunction with the first application and the second application. For example, the second application in the second execution mode may receive a starting point (e.g., unit operation), at which the second application is to interwork, from the first application in the hyperlink form and may be executed from the starting point of the interworking to a specific range (or a specific unit operation) to provide a service function. According to various embodiments, while the second application of the second execution mode is executed, the first application may be in the background state. In an embodiment, the third execution mode may receive the control of the third level (e.g., partial binding) from the first application. For example, the second application in the third execution mode may receive object (or subject) data obtained through image capture from the first application and may recognize the object data to transmit the recognized region of interest (ROI) image data to the related external device. The second application in the third execution mode may receive content associated with the ROI image data from the external device and may display the content through an execution screen of the first application or an interface. In an embodiment, the fourth execution mode may receive the control of the fourth level (e.g., full binding) from the first application. For example, the second application in the fourth execution mode may receive the data result of performing image-processing (e.g., recognition, reading, or the like) on the object (or subject) captured from the first application and may transmit the result data to the related external device. The second application in the fourth execution mode may receive content from the external device and may display the content through an execution screen of the first application or an interface.

In operation 805, the electronic device 100 (e.g., the processor 920 of FIG. 9) may map the identified execution mode information about at least one second application to the corresponding second application to store the mapped result. For example, the electronic device 100 (e.g., the processor 920 of FIG. 9) may establish the database 133 of FIG. 1 of the management module 132 in FIG. 1 by mapping the installed second application to the corresponding execution mode information. According to an embodiment, the electronic device 100 (e.g., the processor 920 of FIG. 9) may identify a second application associated with at least one operation information included in the service scenario of the first application, with reference to the database 133 upon operating the service function through the execution of the first application. The electronic device 100 (e.g., the processor 920 of FIG. 9) may perform function operation control and execution of the first application and the second application of the service operation by identifying the execution mode information of the identified second application.

According to various embodiments, a method of interworking between a host application of an electronic device and an assistant application may include providing the assistant application with at least one operation information corresponding to at least one function among a plurality of functions included in the host application such that the assistant application interworks with a specified function corresponding to the assistant application among the at least one function depending on the at least one operation information and providing the host application with interworking information in which the assistant application interworks with the specified function such that the host application links the assistant application with the specified function based on the interworking information with regard to execution of the host application.

According to various embodiments, the method may further include downloading at least one assistant application associated with the specified function from a specified external device.

According to various embodiments, the downloading may include mapping the downloaded at least one assistant application to at least one execution mode information associated with the downloaded at least one assistant application to store the mapped result.

According to various embodiments, the downloading may include outputting a first user interface for supporting download of the assistant application associated with the specified function from the specified external device, when the host application is executed.

According to various embodiments, the method may further include executing at least one function among the plurality of functions by executing the host application.

According to various embodiments, the executing of the at least one function may include outputting at least one second user interface corresponding to the at least one operation information.

According to various embodiments, the outputting of the at least one second user interface may include displaying identification information associated with the assistant application on the at least one second user interface.

According to various embodiments, the displaying of the identification information may include identifying the assistant application associated with the identification information in response to a user input applied to the identification information.

According to various embodiments, the identifying of the assistant application may include displaying content associated with a function included in the identified assistant application, on the second user interface.

According to various embodiments, the identifying of the assistant application may include executing the identified assistant application and outputting content associated with a function included in the assistant application, through the executed assistant application.

FIG. 9 is a block diagram illustrating an electronic device 901 in a network environment 900 according to various embodiments. Referring to FIG. 9, the electronic device 901 in the network environment 900 may communicate with an electronic device 902 via a first network 998 (e.g., a short-range wireless communication network), or an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) 996, or an antenna module 997. In some embodiments, at least one (e.g., the display device 960 or the camera module 980) of the components may be omitted from the electronic device 901, or one or more other components may be added in the electronic device 901. In some embodiments, some of the components may be implemented as single integrated circuitry. For example, the sensor module 976 (e.g., a fingerprint sensor, an iris sensor, or an illuminance sensor) may be implemented as embedded in the display device 960 (e.g., a display).

The processor 920 may execute, for example, software (e.g., a program 940) to control at least one other component (e.g., a hardware or software component) of the electronic device 901 coupled with the processor 920 and may perform various data processing or computation. According to one embodiment, as at least part of the data processing or computation, the processor 920 may load a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. According to an embodiment, the display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. According to an embodiment, the audio module 970 may obtain the sound via the input device 950 or output the sound via the sound output device 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, a HDMI connector, a USB connector, a SD card connector, or an audio connector (e.g., a headphone connector),

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to one embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. According to an embodiment, the antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 and 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments, a service with various functions may be provided based on the collaboration with an external device.

According to various embodiments, flexible frame work for service collaboration with an external device may be provided.

A variety of effects directly or indirectly understood through this disclosure may be provided.

While the disclosure has been illustrated and described with reference to various example embodiments thereof, it will be understood by those skilled in the art that various changes in form and details may be made therein without departing from the spirit and scope of the disclosure as defined, for example, by the appended claims and their equivalents.

What is claimed is:

1. An electronic device comprising:
a memory configured to store at least one application including a host application having a plurality of functions; and
a management module comprising executable program elements,
wherein the management module is configured to:
provide an assistant application with at least one operation information corresponding to at least one function among the plurality of functions such that the assistant application is configured to interwork with a specified function corresponding to the assistant application among the at least one function depending on the at least one operation information regarding installation of the assistant application for the host application; and
provide the host application with interworking information with which the assistant application is configured to interwork with the specified function such that the host application links the assistant application with the specified function based on the interworking information regarding execution of the host application.

2. The electronic device of claim 1, further comprising:
a communication circuit,
wherein the management module is configured to:
download at least one assistant application associated with the specified function from a specified external device using the communication circuit.

3. The electronic device of claim 2, wherein the management module is configured to:
map the downloaded at least one assistant application to at least one execution mode information associated with the downloaded at least one assistant application to store the mapped result.

4. The electronic device of claim 2, further comprising:
a display; and
a processor electrically connected to the memory, the communication circuit, and the display,
wherein the processor is configured to:
output a first user interface configured to support download of the assistant application associated with the specified function from the specified external device using the display based on the host application being executed.

5. The electronic device of claim 4, wherein the processor is configured to:
output at least one second user interface corresponding to the at least one operation information using the display based on the host application being executed.

6. The electronic device of claim 5, wherein the processor is configured to control the display to:
display identification information associated with the assistant application on the at least one second user interface.

7. The electronic device of claim 6, wherein the processor is configured to control the electronic device to:
receive a user input signal applied to the identification information; and
identify the assistant application associated with the identification information.

8. The electronic device of claim 7, wherein the processor is configured to control the display to:
display content associated with a function included in the identified assistant application on the second user interface.

9. The electronic device of claim 7, wherein the processor is configured to:
execute the identified assistant application; and
output content associated with a function included in the assistant application through the executed assistant application.

10. The electronic device of claim 1, wherein the plurality of functions include at least one of: a product recommendation function, a subject search function, and a subject recognition function, based on an image capture.

11. A method of interworking between a host application of an electronic device and an assistant application, the method comprising:
providing the assistant application with at least one operation information corresponding to at least one function among a plurality of functions included in the host application such that the assistant application interworks with a specified function corresponding to the assistant application among the at least one function depending on the at least one operation information; and
providing the host application with interworking information with which the assistant application interworks with the specified function such that the host application links the assistant application with the specified function based on the interworking information with regard to execution of the host application.

12. The method of claim 11, further comprising:
downloading at least one assistant application associated with the specified function from a specified external device.

13. The method of claim 12, wherein the downloading includes:
mapping the downloaded at least one assistant application to at least one execution mode information associated with the downloaded at least one assistant application to store the mapped result.

14. The method of claim 13, wherein the downloading includes:
outputting a first user interface for supporting download of the assistant application associated with the specified function from the specified external device based on the host application being executed.

15. The method of claim 11, further comprising:
executing at least one function among the plurality of functions by executing the host application.

16. The method of claim 15, wherein the executing of the at least one function includes:
outputting at least one second user interface corresponding to the at least one operation information.

17. The method of claim 16, wherein the outputting of the at least one second user interface includes:
displaying identification information associated with the assistant application on the at least one second user interface.

18. The method of claim 17, wherein the displaying of the identification information includes:
identifying the assistant application associated with the identification information in response to a user input applied to the identification information.

19. The method of claim 18, wherein the identifying of the assistant application includes:
displaying content associated with a function included in the identified assistant application on the second user interface.

20. The method of claim 18, wherein the identifying of the assistant application includes:
executing the identified assistant application; and
outputting content associated with a function included in the assistant application through the executed assistant application.
